(19) United States
(12) Patent Application Publication
(10) Pub. No.: US 2016/0046004 A1
(43) Pub. Date: Feb. 18, 2016

(54) ROD BOX INSTALLATION TOOL DEVICE, AND METHODS OF MAKING AND USING SAME

(71) Applicant: DANIEL LEE HALL, WILLISTON, ND (US)

(72) Inventor: DANIEL LEE HALL, WILLISTON, ND (US)

(21) Appl. No.: 14/458,111

(22) Filed: Aug. 12, 2014

(51) Int. Cl. B25B 13/54; B25B 23/00; E21B 17/042; B25B 19/00

(52) U.S. Cl. CPC B25B 13/54; B25B 19/00; B25B 23/0035; E21B 17/042

(57) ABSTRACT

A rod box installation tool device, and methods of making and using same. The tool device includes a solid cylindrical main body, a rubber-tipped stud member secured to a first end of the main body, and a square cross-section drive aperture provided at a second end of the main body.

### BACKGROUND OF THE INVENTION

The present invention relates generally to a rod box installation tool device, and methods of making and using same.

More particularly, the present invention relates to a a solid cylindrical main body; a rubber-tipped stud member secured to a first end of the main body, and a square cross-section drive aperture provided at a second end of themain body, and methods of making and using same.

The term “box’ as used herein means a coupler for an oil rig.

Sucker rod couplings are an integral part of oil field operations.

A sucker rod is a steel rod, typically between 25 and 30 feet in length, and threaded at both ends, used in the oil industry to join together the surface and downhole components of a reciprocating piston pump installed in an oil well.

It is a desideratum of the present invention to avoid the animadversions of conventional rod box installation tool devices, and to provide a more efficient rod box installation tool device.

### SUMMARY OF THE INVENTION

The present invention provides a rod box installation tool device, comprising: a solid cylindrical main body; a rubber-tipped stud member secured to a first end of said solid cylindrical main body; and a square cross-section drive aperture provided at a second end of said solid cylindrical main body.

The present invention also provides a rod box installation tool device, comprising, in combination: a solid cylindrical main body; a rubber-tipped stud member secured to a first end of said solid cylindrical main body; a square cross-section drive aperture provided at a second end of said solid cylindrical main body; and a rotatable apparatus for selective and releasable insertion into said square cross-section drive aperture provided at a second end of said solid cylindrical main body for imparting rotary motion to said a solid cylindrical main body and said rubber-tipped stud member secured to said first end of said solid cylindrical main body.

The present invention also provides a rod box installation tool device as described hereinabove wherein said a rotatable apparatus comprises a rotary impact tool.

The present invention also provides a rod box installation tool device as described hereinabove wherein said a rotatable apparatus comprises a ratchet extender and a ratchet tool mating therewith.

The present invention also provides a rod box installation tool device, comprising, in combination: a solid cylindrical main body; a rubber-tipped stud member secured to a first end of said solid cylindrical main body; a square cross-section drive aperture provided at a second end of said solid cylindrical main body; a rotatable apparatus for selective and releasable insertion into said square cross-section drive aperture provided at a second end of said solid cylindrical main body for imparting rotary motion to said solid cylindrical main body and said rubber-tipped stud member secured to said first end of said solid cylindrical main body; a sucker rod coupling provide with a first connection portion at a first end thereof and a second connection portion at a second end thereof; a downhole pump member having a threaded portion for threadedly mating with said second connection portion of said sucker rod coupling; said first connection portion having unthreaded section and a threaded section; and said rubber-tipped stud member being selectively and releasably connectible with said unthreaded section of said first connection portion to rotate said sucker rod coupling onto said downhole pump member.

An object of the present invention is to provide a tool designed to make the installation of a rod box faster and easier.

Other objects, advantages, features and modifications of the present invention will become more apparent to those persons skilled in this particular area of technology and to other persons after having been exposed to the present patent application with its accompanying drawings.

### BRIEF DESCRIPTION OF THE SEVERAL VIEWS OF THE DRAWINGS

FIG. 1 shows a perspective view of an apparatus according to a first preferred embodiment of the present invention.

FIG. 2 shows a perspective view of an apparatus according to a second preferred embodiment of the present invention.

FIG. 3 shows an exploded view of partially unassembled portions of FIG. 2.

FIG. 4 shows an assembled view of FIG. 3.

FIG. 5 is sectional view taken along the line 5-5 of FIG. 3 which can also apply to portions of FIG. 1.

### DETAILED DESCRIPTION OF THE INVENTION

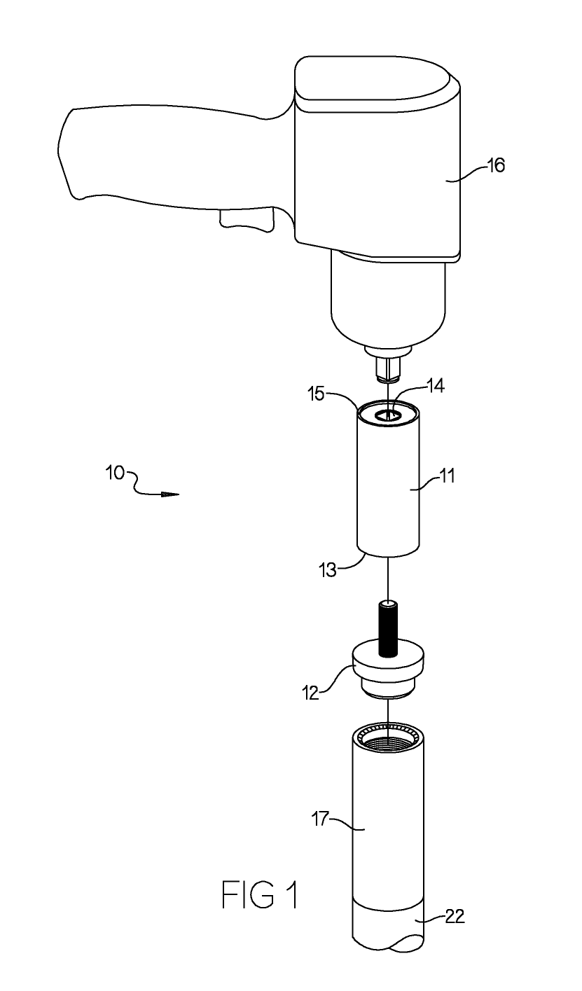

With reference to FIGS. 1 and 5, there is shown a first embodiment of a rod box installation tool device 10.

The device 10 includes a solid cylindrical main body 11, and a rubber-tipped stud member 12 secured to a first end 13 of said solid cylindrical main body 11.

A square cross-sectioned drive aperture 14 is provided at a second end 15 of said solid cylindrical main body 11.

The square cross-sectioned drive aperture 14 is best seen in FIGS. 1 and 5.

The device 10 comprises, in combination, a rotatable apparatus 16 for selective and releasable insertion into said square cross-sectioned drive aperture 14 provided the second end 15 of said solid cylindrical main body 11 for imparting rotary motion to said a solid cylindrical main body 11 and said rubber-tipped stud member 12 secured to said first end 13 of said solid cylindrical main body 11.

The rotatable apparatus may be a rotary impact tool 16.

A sucker rod coupling 17 is provided with a first connection portion 18 at a first end 19 thereof, and a second connection portion 20 at a second end 21 thereof.

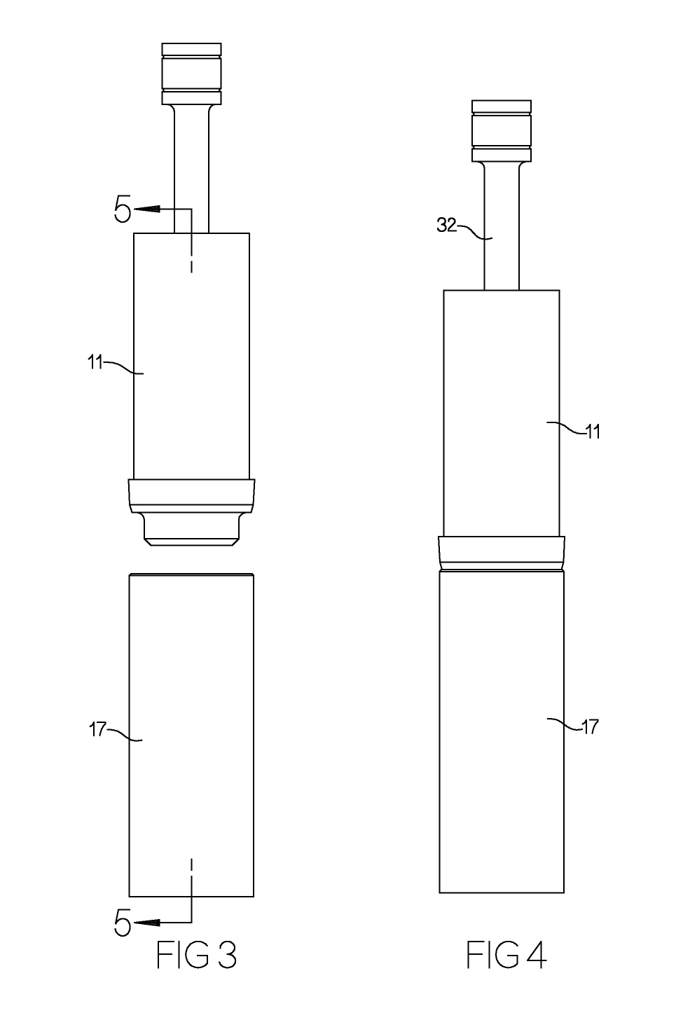

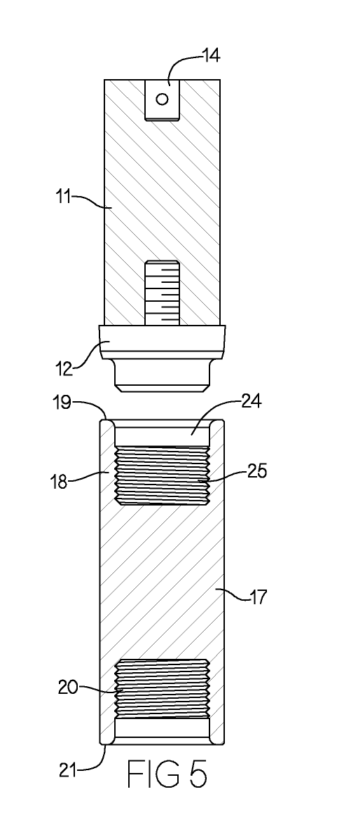

The sucker rod coupling 17 is best seen in FIGS. 1, 3, 4 and 5.

A downhole pump member 22 has a threaded portion (not shown) for threadedly mating with said second connection portion 20 of said sucker rod coupling 17.

The first connection portion 18 has a smooth or unthreaded section 24 and a threaded section 25.

The rubber-tipped stud member 12 is selectively and releasably connectible with the smooth or unthreaded section 24 of said first connection portion 18 to rotate said sucker rod coupling 17 onto said downhole pump member 22.

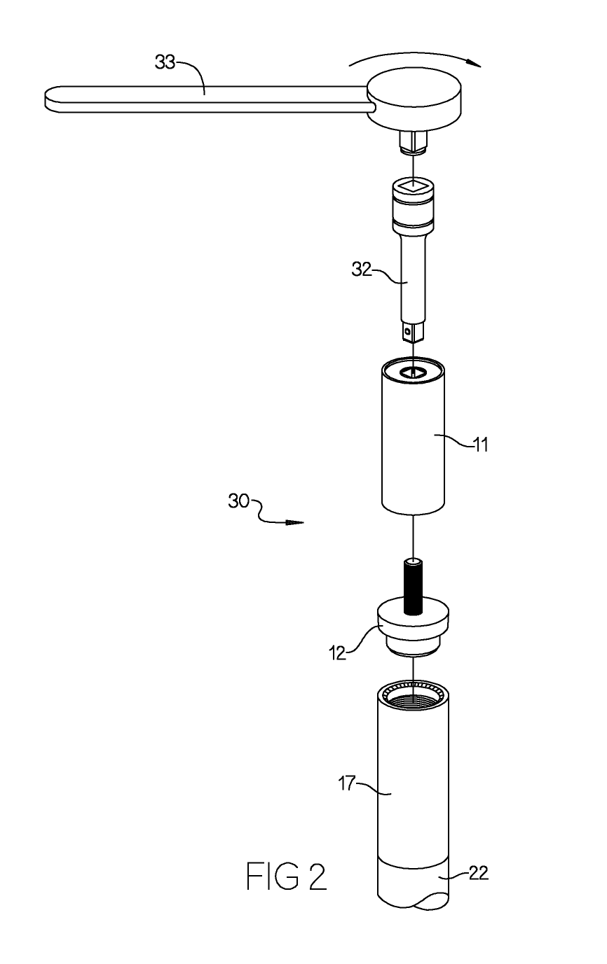

With reference to FIGS. 2 through 5, there is shown a second embodiment of a rod box installation tool device 30.

Similar components of the first and second embodiments are labeled with the same reference numerals

The device 30 includes a solid cylindrical main body 11, and a rubber-tipped stud member 12 secured to a first end 13 of said solid cylindrical main body 11.

A square cross-sectioned drive aperture 14 is provided at a second end 15 of said solid cylindrical main body 11.

The device 10 comprises, in combination, a rotatable apparatus 31 for selective and releasable insertion into said square cross-sectioned drive aperture 14 provided the second end 15 of said solid cylindrical main body 11 for imparting rotary motion to said a solid cylindrical main body 11 and said rubber-tipped stud member 12 secured to said first end 13 of said solid cylindrical main body 11.

The rotatable apparatus 31 includes a ratchet extender 32 and a ratchet tool 33 mating therewith.

A sucker rod coupling 17 is provided with a first connection portion 18 at a first end 19 thereof, and a second connection portion 20 at a second end 21 thereof;

A downhole pump member 22 has a threaded portion 23 for threadedly mating with said second connection portion 20 of said sucker rod coupling 17.

The first connection portion 18 has a smooth or unthreaded section 24 and a threaded section 25.

The rubber-tipped stud member 12 is selectively and releasably connectible with said unthreaded section 24 of said first connection portion 18 to rotate said sucker rod coupling 17 onto said downhole pump member 22.

While the foregoing describes only two exemplary embodiments of the present invention, it is to be understood that the present invention covers all variations, modifications and changes thereof which will occur to those persons skilled in the art and to other persons after having been exposed to the present patent application.

There has been described hereinabove only two of the many possible embodiments of the present invention which can be practiced in many different ways.

Many changes, modifications, variations, and other uses and applications will become apparent to those persons skilled in this particular area of technology and to others after having been exposed to the present patent application.

Any and all such changes, modifications, variations and other uses and applications which do not depart from the spirit and scope of the present invention are therefore covered by and embraced within the patent claims set forth hereinbelow.

1. A rod box installation tool device, comprising:
a solid cylindrical main body;
a rubber-tipped stud member secured to a first end of said solid cylindrical main body; and
a square cross-section drive aperture provided at a second end of said solid cylindrical main body.

2. A rod box installation tool device, comprising, in combination:
a solid cylindrical main body;
a rubber-tipped stud member secured to a first end of said solid cylindrical main body;
a square cross-section drive aperture provided at a second end of said solid cylindrical main body; and
a rotatable apparatus for selective and releasable insertion into said square cross-section drive aperture provided at a second end of said solid cylindrical main body for imparting rotary motion to said a solid cylindrical main body and said rubber-tipped stud member secured to said first end of said solid cylindrical main body.

3. The rod box installation tool device according to claim 2, wherein:
said a rotatable apparatus comprise a rotary impact tool.

4. The rod box installation tool device according to claim 2, wherein:
said a rotatable apparatus comprise a ratchet extender and a ratchet tool mating therewith.

5. A rod box installation tool device, comprising, in combination:
a solid cylindrical main body;
a rubber-tipped stud member secured to a first end of said solid cylindrical main body;
a square cross-section drive aperture provided at a second end of said solid cylindrical main body;
a rotatable apparatus for selective and releasable insertion into said square cross-section drive aperture provided at a second end of said solid cylindrical main body for imparting rotary motion to said a solid cylindrical main body and said rubber-tipped stud member secured to said first end of said solid cylindrical main body;
a sucker rod coupling provide with a first connection portion at a first end thereof and a second connection portion at a second end thereof;
a downhole pump member having a threaded portion for threadely mating with said second connection portion of said sucker rod coupling;
said first connection portion having unthreaded section and a threaded section; and
said rubber-tipped stud member being selectively and releasably connectible with said unthreaded section of said first connection portion to rotate said sucker rod coupling onto said downhole pump member.

6. The rod box installation tool device according to claim 5, wherein:
said a rotatable apparatus comprise a rotary impact tool.

7. The rod box installation tool device according to claim 5, wherein:
said a rotatable apparatus comprise a ratchet extender and a ratchet tool mating therewith.
